(19) United States
(12) Patent Application Publication
(10) Pub. No.: US 2022/0043869 A1
(43) Pub. Date: Feb. 10, 2022

(54) METHODS AND SYSTEMS FOR SEARCHING BASED ON MULTIPLE USER PROFILES

(71) Applicant: Rovi Guides, Inc., San Jose, CA (US)

(72) Inventors: Ankur Anil Aher, Kalyan (IN); Susanto Sen, Bangalore (IN)

(21) Appl. No.: 16/987,082

(22) Filed: Aug. 6, 2020

(51) Int. Cl. G06F 16/9535; G06Q 50/00; G06F 16/2457; H04W 4/02; G10L 15/22; G06F 3/01

(52) U.S. Cl. CPC G06F 16/9535; G06Q 50/01; G06F 16/24578; G06Q 30/0613; G10L 15/22; G06F 3/017; H04W 4/023

(57) ABSTRACT

Systems and methods are described for searching a search query input received from a primary user. A first user profile associated with the primary user is accessed from memory. The proximity of a secondary user to the primary user is determined and compared to a predetermined proximity. The relevance of the secondary user to the search query input is determined. In response to determining that the secondary user is relevant to the search query input, a second user profile associated with the secondary user is accessed from memory. In response to determining that the secondary user is within the predetermined proximity and that the secondary user is a relevant user, at least one of an extension to the search query input and a search result is provided based on the search query input, the first user profile and the second user profile.

### BACKGROUND

The present disclosure relates to methods and systems for searching based on multiple user profiles, and in particular, but not exclusively, to providing search results to a primary user's search query based on their proximity to one or more secondary users.

### SUMMARY

As the amount of content available to users for consumption continues to increase it becomes more difficult for a system to provide relevant search results and recommendations to a user. For example, a conventional system may provide search query results to a user based on their user profile, media consumption history, search history, etc. Moreover, a conventional system does not typically consider the presence of people around the user whilst the user is performing the search. For example, a user who initiates the search may be referred to as a main or primary user interacting with the search system, and a person in close proximity, be it physical and/or virtual proximity, to the main user may be referred to as a secondary user, since they may also have bearing on the search query and/or be interested in the search results. As such, there are many cases where the search results can be improved, e.g., better personalized, filtered and/or presented, if the search system considers the involvement of a secondary user along with the primary user.

Systems and methods are provided herein for searching, e.g., based on multiple user profiles. For example, the systems and methods disclosed herein provide an improved search technique that accounts for the involvement of one or more users in addition to a user who is performing a search.

According to some embodiments of the systems and methods provided herein, a search query input is received from a primary user, e.g., at a user device, such as a computer, smart TV or smartphone. The search query input may be input to a media guidance application. A first user profile associated with the primary user is accessed from memory, e.g., in order to establish one or more user preferences of the primary user following the receiving of the search query input. The proximity of a secondary user to the primary user is determined, e.g., using control circuitry. The proximity of the secondary user to the primary user is compared to a predetermined proximity threshold to determine whether the secondary user is within the predetermined proximity of the primary user. The proximity may be at least one of a spatial, temporal or relationship proximity. The proximity may be at least one of a physical proximity and a virtual proximity. The relevance of the secondary user to the search query input is determined, e.g., in response to determining that the secondary user is within the predetermined proximity of the primary user. In response to determining that the secondary user is relevant to the search query input, a second user profile associated with the secondary user is accessed from memory, e.g., in order to establish one or more user preferences of the secondary user. In response to determining that the secondary user is within the predetermined proximity and that the secondary user is a relevant user, an extension to the search query input may be provided, e.g., at the user device, based on the search query input, the first user profile and the second user profile. In response to determining that the secondary user is within the predetermined proximity and that the secondary user is a relevant user, a search result to the search query input may be provided, e.g., at the user device, based on the search query input, the first user profile and the second user profile.

In some embodiments, determining whether the secondary user is within a predetermined proximity of the primary user may comprise determining whether a distance, e.g., a physical distance, between the primary user and the secondary user is below a distance threshold. In some embodiments, determining whether the secondary user is within a predetermined proximity of the primary user may comprise determining a level of communication between the primary user and the secondary user, e.g., whether a level of communication between the primary user and the secondary user is above or below a communication threshold. Determining the level of communication may comprise determining the amount of and/or frequency of virtual interaction, e.g., by virtue of email, SMS, etc., between the primary user and the secondary user. In some examples, determining the level of communication may be limited to the analysis of communication(s) between the primary user and the secondary user within a timeframe, e.g., 15 minutes, preceding any of the above steps, e.g., the step of receiving the search query input.

In some embodiments, determining the relevance of the secondary user to the search query may comprise determining a physical distance between the secondary user and the user device. In some embodiments, determining the relevance of the secondary user to the search query may comprise determining a viewing direction of the secondary user. In some embodiments, determining the relevance of the secondary user to the search query may comprise analyzing the speech of the secondary user. In some embodiments, determining the relevance of the secondary user to the search query may comprise analyzing one or more gestures of the secondary user. In some embodiments, determining the relevance of the secondary user to the search query may comprise determining the relationship between the primary user and the secondary user.

In some embodiments, in response to determining that the secondary user is not relevant to the search query input, a search history of the secondary user stored in the second user profile may be accessed. Using the search history, it may be determined whether the secondary user has previously made one or more search queries relating to the search query input of the primary user. For example, the search query input of the primary user may be compared with the search history of the secondary user. Where one or more common search terms/topics are found between the search query input of the primary user and the search history of the secondary user, the search result may be provided based the first user profile, the search query input and one or more search queries made by the secondary user relating to the search query input of the primary user.

In some embodiments, the search query input may comprise, at least in part, a factual query. In some embodiments, the search query input may comprise, at least in part, a suggestive query. The search query input may be analyzed to determine whether it comprises at least one of a factual query and a suggestive query. In response to determining that the search query input comprises a suggestive query, the primary user may be added to a relevant user set, e.g., stored in memory. In some embodiments, in response to determining that the secondary user is relevant to the search query input, the secondary user may be added to the relevant user set, e.g., in addition to the primary user.

In some embodiments, the search result may be ranked/sorted based on at least one of the first user profile and the second user profile, e.g., to display one or more search results relevant to one of the primary user and the secondary user above one or more search results relevant to the other of the primary user and the secondary user.

In some embodiments, the search result may be blocked based on at least one of the first user profile and the second user profile, e.g., the search result may be censored to remove or obscure from display one or more items returned as part of the search result.

In some embodiments, the search result may be filtered based on at least one of the first user profile of the primary user and the second user profile of the secondary user.

In some embodiments, the search result may be sorted/ranked, blocked and/or filtered based on the likelihood that the secondary user is relevant to the search input query.

In some embodiments, the search input may comprise a partial search query input, e.g., a partial word or phrase, and one or more options for completing the search query input may be automatically suggested for user selection based on the partial search query input, the first user profile and the second user profile.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 illustrates an overview of a scenario in which a system provides search results for a search query input based on a user's proximity to one or more other users, in accordance with some embodiments of the disclosure;

FIG. 2 is a block diagram showing components of an exemplary system for providing search results for a search query input based on a user's proximity to and/or relationship with one or more other users, in accordance with some embodiments of the disclosure;

FIG. 3 is a flowchart representing a process for providing search results for a search query input based on a user's proximity to one or more other users, in accordance with some embodiments of the disclosure; and

FIG. 4 is a flowchart representing a process for automatically extending/completing a search query input of a user based on the user's proximity to one or more other users, in accordance with some embodiments of the disclosure.

### DETAILED DESCRIPTION

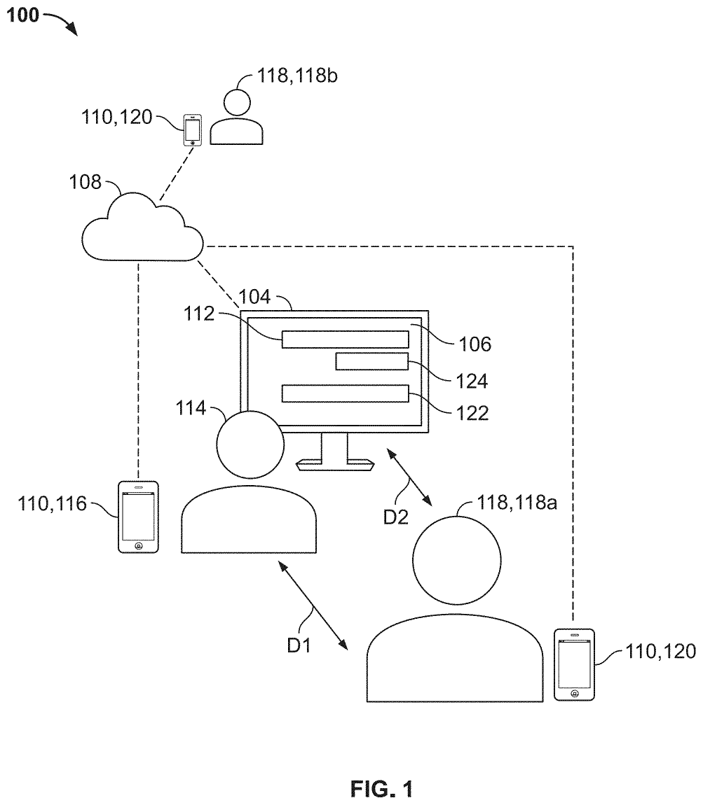

FIG. 1 illustrates an overview of a scenario in which a system provides search results for a search query input based on the proximity and/or the relationship between primary and secondary users, in accordance with some embodiments of the disclosure. In some embodiments, system 100 includes a device 104, such as a tablet computer, a smartphone, a smart television, a smart speaker, or the like, that has one or more various user interfaces configured to interact with one or more nearby users. In some examples, device 104 has a display 106, which is configured to display information via a graphical user interface, and a user input interface, such as a keyboard and/or touchscreen configured to allow the user to input a search query into a search field displayed on the display 106. Additionally or alternatively, the device 104 may have a voice-user interface (not shown), which is configured to receive a natural language query as it is uttered by a nearby user. In some embodiments, device 104 has an audio driver, such as a speaker (not shown), configured to audibly provide information, such as query responses/results, to one or more users. System 100 may also include network 108, such as the Internet, configured to communicatively couple device 104 to one or more user devices 110, e.g., mobile user devices, associated with respective users. Additionally or alternatively, device 104 may be configured to communicatively couple directly with one or more user devices 110. System 100 may also include one or more servers and/or one or more content databases (not shown) from which information relating to the search input may be retrieved. Device 104 and the server may be communicatively coupled to one another by way of network 108, and the server may be communicatively coupled to a content database (not shown) by way of one or more communication paths, such as a proprietary communication path and/or network 108.

In some embodiments, system 100 may comprise an application that provides guidance through an interface that allows users to efficiently navigate (media) content selections and easily identify (media) content that they may desire. Such guidance is referred to herein as an interactive content guidance application or, sometimes, a content guidance application, a media guidance application, or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, chat sessions, social media, applications, games, and/or any other media or multimedia and/or combination of the same. Guidance applications also allow users to navigate amid and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

The media guidance application and/or any instructions for performing any of the embodiments discussed herein may be encoded on computer-readable media. Computer-readable media includes any media capable of storing data. The computer-readable media may be transitory, including, but not limited to, propagating electrical or electromagnetic signals, or may be non-transitory, including, but not limited to, volatile and non-volatile computer memory or storage devices such as a hard disk, floppy disk, USB drive, DVD, CD, media cards, register memory, processor caches, Random Access Memory (RAM), etc.

With the ever-improving capabilities of the Internet, mobile computing, and high-speed wireless networks, users are accessing media on user equipment devices on which they traditionally did not. As referred to herein, the phrases “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smartphone, or any other television equipment, computing equipment, or wireless device, and/or combination of the same. In some embodiments, the user equipment device may have a front-facing screen and a rear-facing screen, multiple front screens, or multiple angled screens. In some embodiments, the user equipment device may have a front-facing camera and/or a rear-facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available through both a television and one or more of the other types of user equipment devices. The media guidance applications may be provided as online applications (i.e., provided on a website), or as stand-alone applications or clients on user equipment devices. Various devices and platforms that may implement media guidance applications are described in more detail below.

One of the functions of the media guidance application is to provide media guidance data to users. As referred to herein, the phrase “media guidance data” or “guidance data” should be understood to mean any data related to content or data used in operating the guidance application. For example, the guidance data may include program information, guidance application settings, user preferences, user profile information, media listings, media-related information (e.g., broadcast times, broadcast channels, titles, descriptions, ratings information (e.g., parental control ratings, critics' ratings, etc.), genre or category information, actor information, logo data for broadcasters' or providers' logos, etc.), media format (e.g., standard definition, high definition, 3D, etc.), on-demand information, blogs, websites, and any other type of guidance data that is helpful for a user to navigate among and locate desired content selections.

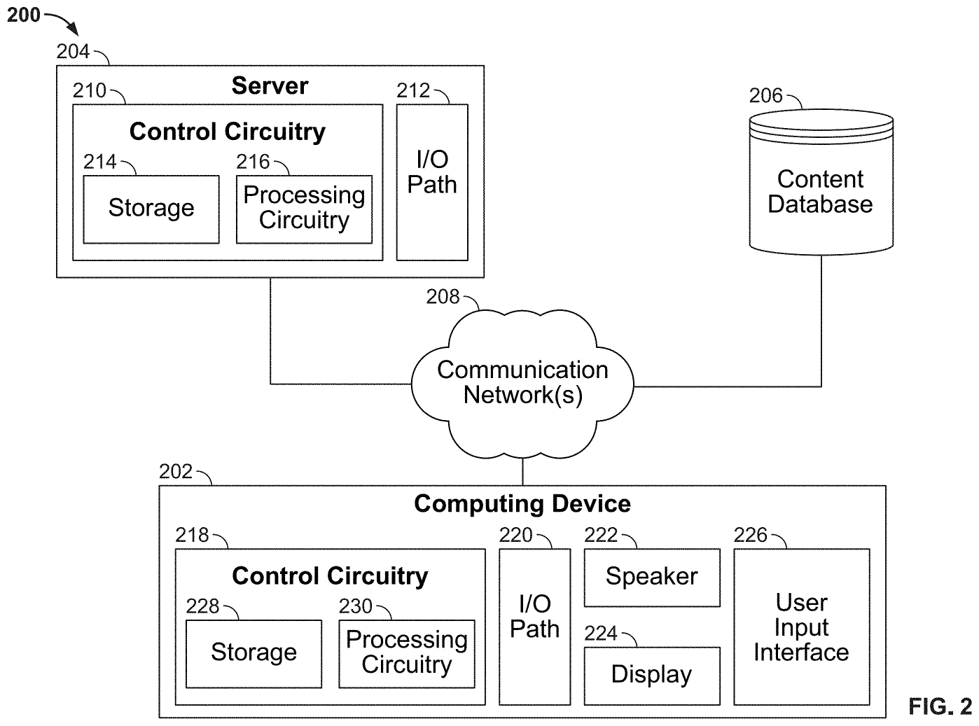

FIG. 2 is an illustrative block diagram showing additional details of an example of system 200 for providing search results based on the proximity and/or relationship between one or more users, in accordance with some embodiments of the disclosure. Although FIG. 2 shows system 200 as including a number and configuration of individual components, in some embodiments, any number of the components of system 200 may be combined and/or integrated as one device, e.g., user device 100. System 200 includes computing device 202, server 204, and content database 206, each of which is communicatively coupled to communication network 208, which may be the Internet or any other suitable network or group of networks. In some embodiments, system 200 excludes server 204, and functionality that would otherwise be implemented by server 204 is instead implemented by other components of system 200, such as computing device 202. In still other embodiments, server 204 works in conjunction with computing device 202 to implement certain functionality described herein in a distributed or cooperative manner.

Server 204 includes control circuitry 210 and input/output (hereinafter “I/O”) path 212, and control circuitry 210 includes storage 214 and processing circuitry 216. Computing device 202, which may be a personal computer, a laptop computer, a tablet computer, a smartphone, a smart television, a smart speaker, or any other type of computing device, includes control circuitry 218, I/O path 220, speaker 222, display 224, e.g., touchscreen 102, and user input interface 226, which in some embodiments includes at least one of voice-user interface configured to receive natural language queries uttered by users in proximity to computing device 202; and a touch/gesture interface configured to receive a touch/gesture input, e.g., a swipe. Control circuitry 218 includes storage 228 and processing circuitry 230. Control circuitry 210 and/or 218 may be based on any suitable processing circuitry such as processing circuitry 216 and/or 230. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores). In some embodiments, processing circuitry may be distributed across multiple separate processors, for example, multiple of the same type of processors (e.g., two Intel Core i9 processors) or multiple different processors (e.g., an Intel Core i7 processor and an Intel Core i9 processor).

Each of storage 214, storage 228, and/or storages of other components of system 200 (e.g., storages of content database 206, and/or the like) may be an electronic storage device. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVRs, sometimes called personal video recorders, or PVRs), solid state devices, quantum storage devices, gaming consoles, gaming media, or any other suitable fixed or removable storage devices, and/or any combination of the same. Each of storage 214, storage 228, and/or storages of other components of system 200 may be used to store various types of content, metadata, and or other types of data. Non-volatile memory may also be used (e.g., to launch a boot-up routine and other instructions). Cloud-based storage may be used to supplement storages 214, 228 or instead of storages 214, 228. In some embodiments, control circuitry 210 and/or 218 executes instructions for an application stored in memory (e.g., storage 214 and/or 228). Specifically, control circuitry 214 and/or 228 may be instructed by the application to perform the functions discussed herein. In some implementations, any action performed by control circuitry 214 and/or 228 may be based on instructions received from the application. For example, the application may be implemented as software or a set of executable instructions that may be stored in storage 214 and/or 228 and executed by control circuitry 214 and/or 228. In some embodiments, the application may be a client/server application where only a client application resides on computing device 202, and a server application resides on server 204.

The application may be implemented using any suitable architecture. For example, it may be a stand-alone application wholly implemented on computing device 202. In such an approach, instructions for the application are stored locally (e.g., in storage 228), and data for use by the application is downloaded on a periodic basis (e.g., from an out-of-band feed, from an Internet resource, or using another suitable approach). Control circuitry 218 may retrieve instructions for the application from storage 228 and process the instructions to perform the functionality described herein. Based on the processed instructions, control circuitry 218 may determine what action to perform when input is received from user input interface 226.

In client/server-based embodiments, control circuitry 218 may include communication circuitry suitable for communicating with an application server (e.g., server 204) or other networks or servers. The instructions for carrying out the functionality described herein may be stored on the application server. Communication circuitry may include a cable modem, an Ethernet card, or a wireless modem for communication with other equipment, or any other suitable communication circuitry. Such communication may involve the Internet or any other suitable communication networks or paths (e.g., communication network 208). In another example of a client/server-based application, control circuitry 218 runs a web browser that interprets web pages provided by a remote server (e.g., server 204). For example, the remote server may store the instructions for the application in a storage device. The remote server may process the stored instructions using circuitry (e.g., control circuitry 210) and/or generate displays. Computing device 202 may receive the displays generated by the remote server and may display the content of the displays locally via display 224. This way, the processing of the instructions is performed remotely (e.g., by server 204) while the resulting displays, such as the display windows described elsewhere herein, are provided locally on computing device 202. Computing device 202 may receive inputs from the user via input interface 226 and transmit those inputs to the remote server for processing and generating the corresponding displays.

A user may send instructions to control circuitry 210 and/or 218 using user input interface 226. User input interface 226 may be any suitable user interface, such as a remote control, trackball, keypad, keyboard, touchscreen, touchpad, stylus input, joystick, voice recognition interface, gaming controller, or other user input interfaces. User input interface 226 may be integrated with or combined with display 224, which may be a monitor, a television, a liquid crystal display (LCD), an electronic ink display, or any other equipment suitable for displaying visual images.

Server 204 and computing device 202 may transmit and receive content and data via I/O path 212 and 220, respectively. For instance, I/O path 212 and/or I/O path 220 may include a communication port(s) configured to transmit and/or receive (for instance to and/or from content database 206), via communication network 208, content item identifiers, content metadata, natural language queries, and/or other data. Control circuitry 210, 218 may be used to send and receive commands, requests, and other suitable data using I/O paths 212, 220.

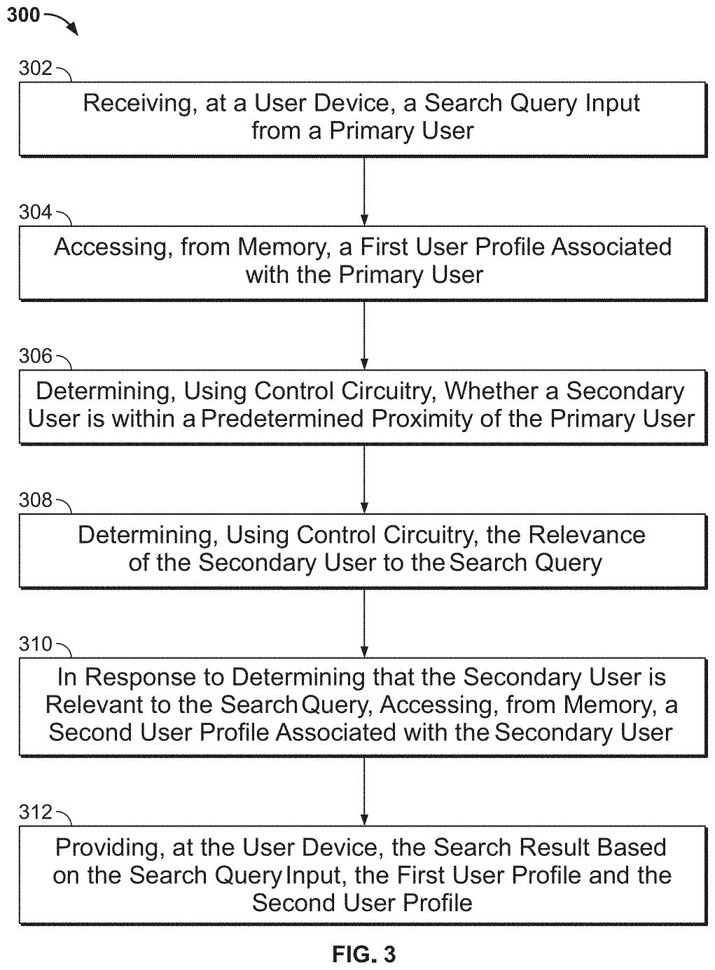

FIG. 3 is a flowchart representing an illustrative process 300 for providing search results to a user's query based on the proximity to and/or relationship with one or more other users, in accordance with some embodiments of the disclosure. Whilst the example shown in FIG. 3 refers to the use of system 100, as shown in FIG. 1, it will be appreciated that the illustrative process shown in FIG. 3, and any of the other following illustrative processes, may be implemented on system 100 and system 200, either alone or in combination, or on any other appropriately configured system architecture.

At step 302, user device 104 receives a search query input 112 from a primary user 114 (first user). In some examples, the primary user 114 may enter the search query input 112 directly into the device 104, e.g., using a user input interface of the device 104. Additionally or alternatively, the primary user 114 may enter the search query input 112 into personal device 116 of the primary user 114, from which the search query input 112 is sent to device 104 for processing. For example, the primary user 114 may enter the search query “Places to visit in California”.

Process 300 may comprise a step of determining if the search query input 112 is an objective query, e.g., whether it is a query that cannot be influenced by personal feelings or opinions of the primary user 114 and/or another user in considering and representing facts. For example, process 300 may comprise a step of determining if the search query input 112 comprises a factual query and/or a suggestive query. In the context of the present disclosure, a “factual query” is a query that cannot be affected by any user or any user preference. For example, a factual query may be “What is the most recent Tom Cruise movie”, or “What is the highest rated restaurant in California”. In each of these examples, the results of the query have no bearing on the identity of the primary user 114 and/or secondary user 118 (second user), nor on any user preference; the results are based solely on facts and cannot be tailored depending on the user. In contrast, a “suggestive query” is a query whose result can be altered/refined depending on the identity of the primary user 114 and/or secondary user 118. For example, a suggestive query may be “Movies to watch on Netflix”, or “Places to visit in California”. In each of these examples, the results of the query may potentially be altered/refined depending on the identity of and/or one or more user preferences of the primary user 114 and/or secondary user 118, since the user is asking for a (personalised) suggestion from the search system. Where it is determined that the search query input 112 does not comprise, at least in part, a suggestive query, process 300 may process the search query input 112 in a typical manner, e.g., in a manner that does not account for the identity of primary user 114 and/or proximity/relationship of one or more secondary users 118 relative to the primary user 114. Where it is determined that the search query input 112 does comprise, at least in part, a suggestive query, process 300 moves to step 304. Where it is determined that the search query input 112 does not comprise, in any part, a suggestive query, process 300 may be terminated and the search query input may be processed in a conventional manner.

At step 304, a user profile of the primary user 114 (first user profile) is accessed, e.g., from memory stored on at least one of device 104, the primary user's device 116 and a server, such as server 214. The user profile may store any appropriate information relating to the primary user, e.g., user identity, user preference, search history, media content viewing history, etc. Once accessed, the user profile of the primary user 114 may be added to a relevant user set stored on device 104, which may be accessed for later use when processing the results of the search query input 112. In a conventional system, the information in a user's profile may be used to provide more relevant search results to the user, e.g., by basing the search results, in part, on a previous search that the user performed or a webpage that the user has previously visited. However, such a system does not account for the user's interaction with other people (present or recent) or the presence of people around the user whilst the user is performing the search.

At step 306, control circuitry determines whether one or more secondary users 118 are within a predetermined proximity of the primary user 114. In the context of the present disclosure, the term “proximity” is understood to mean nearness in space, time, and/or relationship. As such, the predetermined proximity may be a threshold relating to at least one of the spatial, temporal and relationship proximity between the primary user and at least one secondary user 118. The proximity may be at least one of physical proximity and virtual proximity. For example, physical proximity may relate to the physical distance between the primary user 114 and one or more secondary users 118. In the example shown in FIG. 1, secondary user 118a is a physical distance D1 away from the primary user 114. As such, step 306 may comprise determining if the secondary user 118, e.g., secondary user 118a, is less than a certain distance, e.g., 2 m, away from the primary user 114. For example, it is common for a multiple people, e.g., a couple, to be in the same room or sit together when performing a search, e.g., for a restaurant to dine at or for a movie to watch. Thus, determining if the physical distance between primary user 114 and one or more secondary users 118 is less than a predetermined distance indicates that the presence of the secondary user 118 may have bearing on the search query input by the primary user 114. The physical distance between the primary user 114 and the secondary user 118 may be determined using any appropriate technique using control circuitry. For example, device 104 may comprise means for determining the location of the secondary user 118a relative to the primary user 114. In some examples, spatial measurements may be taken using one or more optical techniques, such as infra-red or laser-based measurement techniques. Additionally or alternatively, spatial measurements may be taken using one or more image processing techniques, e.g., using an image or video captured using a camera of device 104. Additionally or alternatively, the distance between primary user 114 and secondary user 118a may be determined using (location) data gathered, e.g., via network 108, from the user devices 116, 120 of the primary user 114 and the secondary user 118 respectively.

In a similar manner, determining if the primary user 114 has been in (recent) communication with a secondary user 118, e.g., secondary user 118b, may help determine that a secondary user 118 is within a predetermined proximity of the primary user 114. For example, step 306 may comprise determining with whom the primary user 114 has interacted/communicated, e.g., within a certain time limit. Interaction/communication between a primary user 114 and a secondary user 118 may be a virtual interaction, e.g., one or more conversations over email, telephone, SMS, video chat and/or social media, etc. In the example shown in FIG. 1, control circuitry is configured to determine the (virtual) proximity between the primary user 114 and at least one secondary user 118, e.g., secondary user 118a and/or secondary user 118b, by analyzing a communication log of at least one user device 116, 120 of the primary and/or secondary user 114, 118, respectively. The communication log may comprise telephone call history, email history, SMS history, social media chat history, and/or any other appropriate history relating to communication between the primary user 114 and one or more secondary users 118. Step 306 may comprise restricting analysis of communication history to within a certain time frame. For example, step 306 may comprise determining with whom the primary user 114 has been in contact with recently, e.g., within the last five minutes. Additionally or alternatively, step 306 may comprise determining the frequency with which the primary user 114 communicates with a secondary user 118. For example, step 306 may comprise determining that the primary user 114 has had an exchange of messages with one or more secondary users 118, e.g., within a predetermined time period. Thus, where the primary user 114 has had an exchange of communication, such as six messages back and forth, with a secondary user 118, e.g., within the last 15 minutes, it may be determined that the secondary user 118 is within the predetermined (virtual) proximity of the primary user 114. In some examples, step 306 may comprise determining whether a level of communication between the primary user and the secondary user is above a communication threshold. The communication threshold may be set at any appropriate level, e.g., a predetermined number of communications, optionally within a predetermined time period.

At step 308, control circuitry determines the relevance of one or more secondary users 118 to the search query input 112. For example, where it has been determined that secondary user 118a is within a predetermined (physical) proximity of the primary user 114, control circuitry may determine the relevance of secondary user 118a to the search query input 112. Additionally or alternatively, where it has been determined that secondary user 118b is within a predetermined (virtual) proximity of the primary user 114, control circuitry may determine the relevance of secondary user 118b to the search query input 112.

In the context of the present disclosure, a “relevant” user is understood to mean a user who has bearing on the search intent of the primary user 114 and/or a user whose preferences might affect the search results. For example, a relevant secondary user might be user that is involved with and/or participating in the search. Such a situation may arise where multiple people are searching for media content to view communally using a media guidance application. In such a case, the primary user 114 would be the user who is controlling the user input interface, and each of the other people would be a relevant secondary user 118, since they are also interested in the media content item selected for communal viewing. In another situation, a couple, e.g., a husband and wife, may be searching together for “Places to visit in California”—in such a case, the primary user 114 would be the person in the couple controlling the user input interface, whilst the other person in the couple would be a relevant secondary user 118, since they are also interested in the results of the search. In other situations, the primary user 114 may be performing the search in close proximity to other people, e.g., where the primary user 114 is using a computer in a public place—in this case, secondary users 118 surrounding the primary user 114 that fall within the predetermined proximity may still have bearing on the search intent of the primary user 114, even though they are strangers to the primary user 114, since the primary user 114 might wish to censor/restrict content items that are returned during the search, when performed in a public place. As such, step 308 of determining the relevance of the secondary user 118 to the search query input 112 may comprise determining an involvement score of the secondary user 118. Where the involvement score is greater than an involvement score threshold, the secondary user 118 may be classified as a relevant user.

In some examples, determining the relevance of the secondary user 118 to the search query may comprise determining a physical distance between the secondary user 118 and the device being used by the primary user 114 to perform the search. In the example shown in FIG. 1, control circuitry may be configured to determine distance D2 between the secondary user 118a and the user device 104, e.g., in a similar manner to that used in step 306. Where distance D2 is less than a predetermined distance, e.g., 1 m, the secondary user 118a may be classified as a relevant secondary user 118, since their proximity to the primary user 114 and the device 104 indicates a high probability that they are involved in the search.

Additionally or alternatively, step 308 may comprise determining the likelihood that the secondary user 118 is a relevant secondary user 118 based on a level of interaction of the secondary user 118 with the primary user 114 and/or the device 104 being used by the primary user 114. For example, step 308 may comprise at least one of determining a viewing direction of the secondary user, e.g., in relation to a display of the device 104 displaying the search input query 112; tracking the gaze of the secondary user 118, e.g., to determine if the secondary user 118 is focussed on the search query input 112; analyzing the speech of the secondary user 118, e.g., to determine if the secondary user's speech is relevant to at least a portion of the search query input 112; analyzing one or more gestures of the secondary user 118, e.g., to determine if the secondary user 118 is gesturing towards the search query input 112 and/or the primary user 114, as the primary user 114 inputs the search query. Control circuitry may be configured to then compute the involvement score of the secondary user 118 based on at least one of the above factors. For example, control circuitry may be configured to assign a count to each of the above factors where they are satisfied, such that the probability that the secondary user 118 is relevant to the search query may be determined. For example, where the secondary user 118a is within a predetermined distance of the device 104, e.g., distance D2 is less than 1 m, a count of 1 may be assigned to the involvement score. In a similar manner, a (further) count of 1 may be assigned to the involvement score when each of the other factors contributing to the level of interaction between the secondary user 118 and the primary user 114 and/or the user device 104 is satisfied. In some examples, the secondary user 118 may be determined to be a relevant user when the count is above the involvement score threshold, e.g., two. In some cases, each of the above factors may carry a different weighting when assessing the likelihood that the secondary user 118 is relevant to the search input query. For example, the proximity of the secondary user 118 to the user device 104 may carry a higher weighting than the analysis of the secondary user's gestures and/or speech, for instance.

Additionally or alternatively, control circuitry may be configured to analyze information stored in memory of a user device 110 of a secondary user 118 to determine if the secondary user 118 is a relevant user. For example, control circuitry may be configured to access search history of the secondary user 118 and/or parse text of one or more communications, e.g., an email or a SMS communications, of the secondary user 118 to determine if the secondary user 118 has searched for and/or discussed a topic similar to that of the search query input 112. Where one or more similar topics are found, control circuitry may assign each instance of a matching topic a count that contributes to the involvement score of the secondary user 118. For example, where the search input query 112 comprises the phrase “Places to visit in California”, control circuitry may be configured to determine if information stored in memory of the user device 110 of the secondary user 118 contains information relating to at least a portion of the search input query 112, such as the term “California”, or topics, such as “vacation” or “travel”, that may demonstrate a relation between the information stored on the user device 110 and the search input query 112.

At step 310, in response to determining that the secondary user 118 is relevant to the search query input, control circuitry accesses, from memory, a user profile associated with the secondary user 118 (second user profile). The second user profile may be stored on memory of at least one of device 104, the secondary user's device 120 and a server, such as server 214. The second user profile may store any appropriate information relating to the secondary user, e.g., user preference, search history, media content viewing history, etc. Once accessed, the second user profile may be added to the relevant user set stored on device 104, which may be accessed, e.g., along with the profile of the primary user 114 (first user profile), for later use when processing the results of the search query import 112.

At step 312, control circuitry provides, e.g., at user device 104, a search result 122 based on the search query input 112, the first user profile and the second user profile. In this manner, the search result 122 is contextualized based on the environment in which the primary user 114 is performing the search. For example, where it has been determined that the primary user 114 is performing the search within a predetermined proximity of one or more relevant secondary users 118, the search system can consider the common interests of all involved users and display the results appropriately, e.g., by filtering, blocking, ranking and/or sorting one or more items contained in the search result, depending on the secondary user or users 118 who are involved in the search along with the primary user 114. For example, the user profile of the primary user 114 may indicate that they are interested in nature, beaches and nightlife, and the user profile of the secondary user 118 may indicate that they are interested in theme parks, driving and nightlife. As such, where the primary user 114 inputs the search query “Places to visit in California”, the search result(s) 122 may provide places to visit in California that are reported to have a good nightlife, since both parties share nightlife as a common interest.

In some examples, process 300 may comprise a step of determining if there is a relationship between the primary user 114 and the secondary user 118. For example, process 300 may analyze the profiles of the primary user 114 and the secondary user 118 to determine if there is a family, friend, work and/or school relationship (or any other type of relationship) between the primary user 114 and the secondary user 118. For example, the relationship between the primary user 114 and the secondary user 118 might be a parent-child relationship. As such, where a parent is searching for “Places to visit in California” in the presence of their child, search results 122 may be filtered based on locations in California that are popular for family holidays. In another example, the relationship between the primary user 114 and the secondary user 118 might be a husband-wife relationship. As such, where a husband is searching for “Places to visit in California” in the presence of his wife, search results 122 may be filtered based on locations in California that are popular for romantic holidays. In another example, the relationship between the primary user 114 and the secondary user 118 might be a teacher-pupil relationship. As such, where a teacher is searching for “Places to visit in California” in the presence of their pupil, search results 122 may be limited to locations in California that are age-appropriate for the pupil, and/or may censor or restrict search results so as not to divulge personal information about the teacher to the pupil.

In some cases, the primary user's profile (first profile) may carry a larger weighting than a secondary user's profile (second profile), such that the search result 122 may be displayed having results relevant to the primary user 114 displayed more prominently, e.g., at a higher position in a list, than results relevant to the secondary user 118.

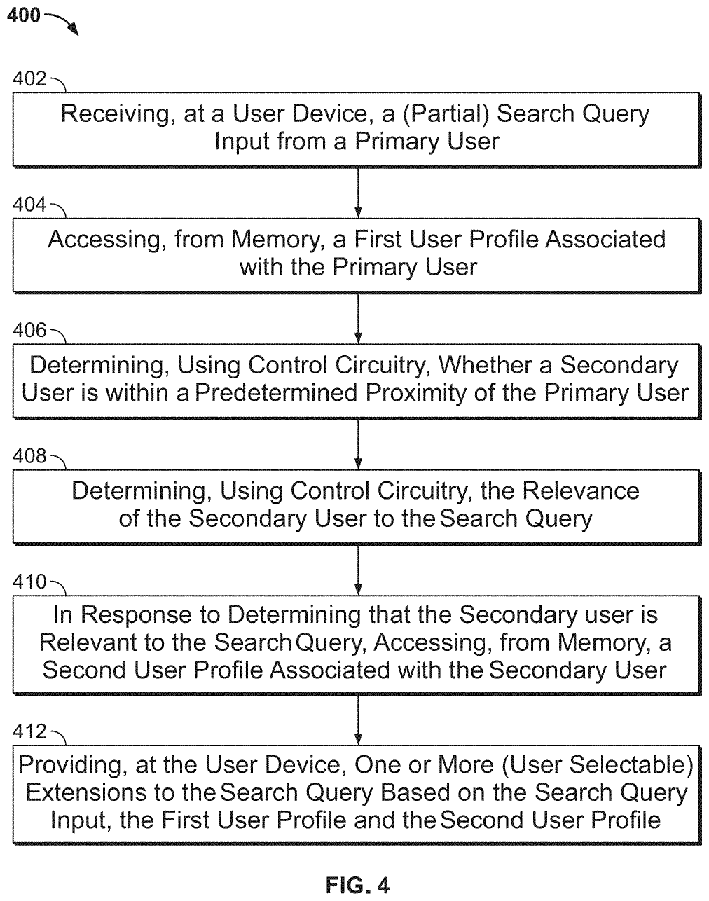

The actions or descriptions of FIG. 3 may be used with any other embodiment of this disclosure, e.g., the embodiment described below in relation to FIG. 4. In addition, the actions and descriptions described in relation to FIG. 3 may be done in any suitable alternative orders or in parallel to further the purposes of this disclosure.

FIG. 4 is a flowchart representing an illustrative process 400 for automatically extending/completing a search query input of a user based on the user's proximity to and/or relationship with one or more other users, in accordance with some embodiments of the disclosure. Whilst the example shown in FIG. 4 refers to the use of system 100, as shown in FIG. 1, it will be appreciated that the illustrative process shown in FIG. 4 may be implemented on system 100 and system 200, either alone or in combination, or on any other appropriately configured system architecture.

At step 402, user device 104 receives a (partial) search query input 112 from a primary user 114. In some examples, the primary user 114 may enter the search query input 112 directly into the device 104, e.g., using a user input interface of the device 104. Additionally or alternatively, the primary user 114 may enter the partial search query input 112 into personal device 116 of the primary user 114, from which the search query input 112 is sent to device 104 for processing. For example, the primary user 114 may enter the search query “Places to visit in California”.

Step 404 may be carried out in a manner similar to that of step 304.

Step 406 may be carried out in a manner similar to that of step 306.

Step 408 may be carried out in a manner similar to that of step 308.

Step 410 may be carried out in a manner similar to that of step 310.

At step 412, control circuitry provides, e.g., at user device 104, an extension 124 to the search query input 112 based on the search query input 112, the first user profile and the second user profile. In the context of the present disclosure, the term “extension” refers to one or more further letters, words, phrases, images and/or search terms that can be used in combination with the search query input 112 to help narrow the field of the search. Techniques of providing an extension to a search query input may be referred to as “auto-suggest” techniques. For example, where a user searches for the term “Places to visit in California”, a conventional search system may auto-suggest the additional terms “during winter” or “for Christmas celebration”, e.g., based upon the time of year that the user is performing the search or the search history of the user. However, such conventional systems do not account for the preferences of other (secondary) users who may be in the vicinity of the (primary) user who is performing the search when auto-suggesting one or more extensions to the search query input 112. In contrast, process 400 provides an extension 124 to the search query input 112 that is contextualized based on the environment in which the primary user 114 is performing the search. For example, where it has been determined that the primary user 114 is performing the search within a predetermined proximity of one or more relevant secondary users 118, the search system can consider the common interests of all involved users and suggest one or more appropriate extensions 124 to the search query input 112, depending on the secondary user or users 118 who are involved in the search along with the primary user 114. For example, the user profile of the primary user 114 may indicate that they are interested in nature, beaches and nightlife, and the user profile of the secondary user 118 may indicate that they are interested in theme parks, driving and nightlife. As such, where the primary user 114 inputs the search query “Places to visit in California”, the extension “with good nightlife” may be provided, since both parties share nightlife as a common interest.

In some examples, process 400 may comprise a step of determining if there is a relationship between the primary user 114 and the secondary user 118. For example, process 400 may analyze the profiles of the primary user 114 and the secondary user 118 to determine if there is a family, friend, work and/or school relationship (or any other type of relationship) between the primary user 114 and the secondary user 118. For example, the relationship between the primary user 114 and the secondary user 118 might be a parent-child relationship. As such, where a parent is searching for “Places to visit in California” in the presence of their child, extension 124 may comprise one or more additional search terms, such as “for families” and/or “with children”, for instance. In another example, the relationship between the primary user 114 and the secondary user 118 might be a husband-wife relationship. As such, where a wife is searching for “Places to visit in California” in the presence of her husband, extension 124 may comprise one or more additional search terms, such as “for couples” and/or “for a romantic break”.

In some cases, the secondary user's profile may carry a larger weighting than the primary user's profile, such that an extension 124 that is relevant to the secondary user 118 is displayed more prominently, e.g., at a higher position in a list, than another extension 124 that is relevant to the primary user 114. For example, where the secondary user's profile indicates a strong preference for a certain interest or limited interests, e.g., art (because they are an artist), the extension “for art lovers” may be provided, despite the primary user's profile showing only a minor interest in the subject of art. In this manner, process 400 provides a method of providing one or more auto-suggested extensions 124 to a search query input 112, the one or more extensions 124 being provided based upon the context and environment in which the primary user 114 is performing the search.

The actions or descriptions of FIG. 4 may be used with any other embodiment of this disclosure. In addition, the actions and descriptions described in relation to FIG. 4 may be done in any suitable alternative orders or in parallel to further the purposes of this disclosure.

The processes described above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A search method comprising:
receiving, at a user device, a search query input from a primary user;
accessing, from memory, a first user profile associated with the primary user;
determining, using control circuitry, whether a secondary user is within a predetermined proximity of the primary user;
determining, using control circuitry, the relevance of the secondary user to the search query input;
in response to determining that the secondary user is relevant to the search query input, accessing, from memory, a second user profile associated with the secondary user; and
providing, at the user device, at least one of:
an extension to the search query input based on the search query input, the first user profile and the second user profile; and
a search result based on the search query input, the first user profile and the second user profile.

2. The method of claim 1, wherein determining whether the secondary user within a predetermined proximity of the primary user comprises at least one of:
determining whether a distance between the primary user and the secondary user is below a distance threshold; and
determining whether a level of communication between the primary user and the secondary user is above a communication threshold.

3. The method of claim 1, wherein determining the relevance of the secondary user to the search query comprises at least one of:
determining a physical distance between the secondary user and the user device;
determining a viewing direction of the secondary user;
analyzing the speech of the secondary user;
analyzing one or more gestures of the secondary user; and
determining the relationship between the primary user and the secondary user.

4. The method of claim 1, the method comprising, in response to determining that the secondary user is not relevant to the search query input:
accessing the second user profile;
accessing a search history of the secondary user stored in the second user profile;
determining, from the search history, whether the secondary user has previously made one or more search queries relating to the search query input of the primary user; and
providing the search result based the first user profile, the search query input and one or more search queries made by the secondary user relating to the search query input of the primary user.

5. The method of claim 1, the method comprising:
determining whether the search query input comprises at least one of a factual query and a suggestive query; and
in response to determining that the search query input comprises a suggestive query, adding the primary user to a relevant user set.

6. The method of claim 5, the method comprising, in response to determining that the secondary user is relevant to the search query input, adding the secondary user to the relevant user set.

7. The method of claim 1, the method comprising ranking the search result based on the first user profile and the second user profile.

8. The method of claim 1, the method comprising blocking the search result based on the first user profile and the second user profile.

9. The method of claim 1, the method comprising filtering the search result based on the first user profile and the second user profile.

10. The method of claim 1, wherein the search input comprises a partial search query input, and the method further comprises automatically suggesting for user selection one or more options for completing the search query input based on the partial search query input, the first user profile and the second user profile.

11. A searching system, the system comprising:
control circuitry configured to:
receive, at a user device, a search query input from a primary user;
access, from memory, a first user profile associated with the primary user;
determine, using control circuitry, whether a secondary user is within a predetermined proximity of the primary user;
determine, using control circuitry, the relevance of the secondary user to the search query input;
in response to determining that the secondary user is relevant to the search query input, access, from memory, a second user profile associated with the secondary user; and
provide, at the user device, at least one of:
an extension to the search query input based on the search query input, the first user profile and the second user profile; and
a search result based on the search query input, the first user profile and the second user profile.

12. The system of claim 11, wherein the control circuitry, when determining whether the secondary user is within a predetermined proximity of the primary user, is configured to at least one of:
determine whether a distance between the primary user and the secondary user is below a distance threshold; and
determine whether a level of communication between the primary user and the secondary user is above a communication threshold.

13. The system of claim 11, wherein the control circuitry, when determining the relevance of the secondary user to the search query, is configured to at least one of:
determine a physical distance between the secondary user and the user device;
determining a viewing direction of the secondary user;
analyzing the speech of the secondary user;
analyzing one or more gestures of the secondary user; and
determining the relationship between the primary user and the secondary user.

14. The system of claim 11, wherein, in response to determining that the secondary user is not relevant to the search query input, the control circuitry is configured to:
access the second user profile;
access a search history of the secondary user stored in the second user profile;
determine, from the search history, whether the secondary user has previously made one or more search queries relating to the search query input of the primary user; and
in response to determining that the secondary user has previously made one or more search queries relating to the search query input of the primary user, provide the search result based the first user profile, the search query input and one or more search queries made by the secondary user relating to the search query input of the primary user.

15. The system of claim 11, wherein the control circuitry is configured to:
determine whether the search query input comprises at least one of a factual query and a suggestive query; and
in response to determining that the search query input comprises a suggestive query, add the primary user to a relevant user set.

16. The system of claim 15, wherein the control circuitry is configured to, in response to determining that the secondary user is relevant to the search query input, add the secondary user to the relevant user set.

17. The system of claim 11, wherein the control circuitry is configured to rank the search result based on the first user profile and the second user profile.

18. The system of claim 11, wherein the control circuitry is configured to block the search result based on the first user profile and the second user profile.

19. The system of claim 11, wherein the control circuitry is configured to filter the search result based on the first user profile and the second user profile.

20. The system of claim 11, wherein the search input comprises a partial search query input, and the control circuitry is configured to automatically suggest for user selection one or more options for completing the search query input based on the partial search query input, the first user profile and the second user profile.

21.-40. (canceled)
